(19) United States
(12) Patent Application Publication
(10) Pub. No.: US 2026/0211854 A1
(43) Pub. Date: Jul. 23, 2026

(54) SYSTEM AND METHOD FOR MIGRATING DATABASE CONTENTS OF AN SAP SYSTEM

(71) Applicant: LEMONGRASS HOLDINGS, INC., EWING, NJ (US)

(72) Inventor: Ravi Sankar ATHMAKURI, Ewing, NJ (US)

(73) Assignee: LEMONGRASS HOLDINGS, INC., EWING, NJ (US)

(21) Appl. No.: 19/139,165

(22) PCT Filed: Dec. 19, 2023
(86) PCT No.: PCT/US2023/084928

§ 371 Date: Jun. 13, 2025

Related U.S. Application Data
(60) Provisional application No. 63/484,293, filed on Feb. 10, 2023.

(30) Foreign Application Priority Data
Dec. 22, 2022 (IN) 202211074555

(51) Int. Cl. G06F 16/21; G06F 16/23

(52) U.S. Cl. CPC G06F 16/214; G06F 16/2358; G06F 16/2372

(57) ABSTRACT

A computing system receives a request to generate a migration plan for migrating data from an SAP system to a target cloud environment. The computing system accesses the data hosted by the SAP system. The computing system generates the migration plan for migrating the data from the SAP system to the target cloud environment. The migration plan includes an online phase and an offline phase. In the online phase, stable data and a first portion of active data that has not changed within a threshold period of time is migrated to the target cloud environment. In the offline phase, a second portion of the active data that has changed within the threshold period of time is migrated to the target cloud environment. The computing system causes the data to be migrated from the SAP system to the target cloud environment in accordance with the migration plan.

### CROSS-REFERENCE TO RELATED APPLICATIONS

This application claims priority to Indian Patent Application No. 202211074555, filed Dec. 22, 2022, and U.S. Provisional Ser. No. 63/484,293, filed Feb. 10, 2023, which are both hereby incorporated by reference in their entireties.

### FIELD OF THE DISCLOSURE

Embodiments disclosed herein generally relate to a system and method of ‘migrating database contents of an SAP system’ (also called Heterogeneous System Copy or OS/DB Migration Process) to a cloud environment, with significantly reduced downtime as compared to the traditional offline method prescribed by SAP.

### BACKGROUND

The increasing adoption of cloud computing offers numerous advantages, such as scalability, flexibility, and cost-efficiency. However, the process of migrating data from systems as complex as SAP systems, poses unique challenges. For example, users need to ensure that data integrity is maintained throughout the migration process, which can be difficult when active data ranges are constantly changing.

### SUMMARY

In some embodiments, a method of migrating a database from an SAP system to a target cloud environment is disclosed herein. A computing system receives a request to generate a migration plan for migrating data from an SAP system to a target cloud environment. The computing system accesses the data hosted by the SAP system. The computing system generates the migration plan for migrating the data from the SAP system to the target cloud environment. The migration plan includes an online phase and an offline phase. In the online phase, stable data and a first portion of active data that has not changed within a threshold period of time is migrated to the target cloud environment. In the offline phase, a second portion of the active data that has changed within the threshold period of time is migrated to the target cloud environment. The computing system causes the data to be migrated from the SAP system to the target cloud environment in accordance with the migration plan.

In some embodiments, a non-transitory computer readable medium is disclosed herein. The non-transitory computer readable medium includes one or more sequences of instructions, which, when executed by a processor, causes a computing system to perform operations. The operations include receiving, by the computing system, a request to generate a migration plan for migrating data from an SAP system to a target cloud environment. The operations further include accessing, by the computing system, the data hosted by the SAP system. The operations further include generating, by the computing system, the migration plan for migrating the data from the SAP system to the target cloud environment. The migration plan includes an online phase and an offline phase. In the online phase, stable data and a first portion of active data that has not changed within a threshold period of time is migrated to the target cloud environment. In the offline phase, a second portion of the active data that has changed within the threshold period of time is migrated to the target cloud environment. The operations further include causing, by the computing system, the data to be migrated from the SAP system to the target cloud environment in accordance with the migration plan.

In some embodiments, a system is disclosed herein. The system includes a processor and a memory. The memory has programming instructions stored thereon, which, when executed by the processor, causes the system to perform operations. The operations include receiving a request to generate a migration plan for migrating data from an SAP system to a target cloud environment. The operations further include accessing the data hosted by the SAP system. The operations further include generating the migration plan for migrating the data from the SAP system to the target cloud environment. The migration plan includes an online phase and an offline phase. In the online phase, stable data and a first portion of active data that has not changed within a threshold period of time is migrated to the target cloud environment. In the offline phase, a second portion of the active data that has changed within the threshold period of time is migrated to the target cloud environment. The operations further include causing the data to be migrated from the SAP system to the target cloud environment in accordance with the migration plan.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a flow diagram illustrating a method of generating a migration plan for migrating data from an SAP platform to a target cloud environment, according to example embodiments.

FIG. 3 is a block diagram illustrating a comparison between a base enhanced migration process and a migration process using a migration service, according to example embodiments.

FIG. 4A illustrates a system bus computing system architecture, according to example embodiments.

FIG. 4B illustrates a computer system having a chipset architecture, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments disclosed herein generally relate to an improved method for migrating content from an existing SAP system running on non-x86 microprocessor architecture, hereinafter called a source location, to a new SAP system running on an x86-based microprocessor architecture, hereinafter called a target location. Additionally, this improved method can be used to migrate the contents of an SAP system when the supporting database type changes between the source and the target locations irrespective of the underlying microprocessor architecture or when the data is converted from non-Unicode to Unicode encoding scheme (also called the codepage change for SAP data). In particular, one or more embodiments described herein provide an improved approach for migrating the database contents of an SAP system to a target location by minimizing the amount of data that needs to be migrated in an offline phase of the migration process. By decreasing the amount of data that needs to be migrated in the offline phase and migrating a significant amount of data in the online phase, the present approach can perform a migration process with limited downtime. It is to be noted that SAP provides a standard method and associated set of tools to affect such a migration, which in its traditional embodiment requires that the application be stopped for the entire database contents to be migrated to the destination location, i.e., business users incur an extended SAP application downtime during such migrations.

In some embodiments, embodiments disclosed herein further improve upon an enhancement to the standard SAP migration process that was originally designed to reduce the downtime incurred due to online migration of the top few tables. However, such an approach suffered from limitations on what type of tables could be handled and how much downtime could be reduced. Accordingly, while the enhanced migration approach handled a fair amount of data during the online phase; such an approach still had to process a non-trivial amount of data during the offline phase. Typically, this approach could be applied to certain types of tables during the online phase. For example, using the enhanced migration approach, only those tables that included a date field or tables with a key field that reliably had a sequential and single number range order could be processed. As a result, the enhanced migration process would be unable to process the latest three to four months'worth of data in the online phase; instead, this recent data had to wait for the offline migration phase. Exemplary tables that could be processed during the online phase include, but are not limited to, tables in SAP Enterprise Core Component (ECC) system like BSIS, FAGLFLEXA, GLPCA, etc., which have date-based field; and tables like SOFFCONT1, CDCLS, which have a sequential key field, that has higher values for the latest data. In operation, a key value from 3 or 4 months back may be chosen as the cut-off between online and offline ranges. This key value may provide the benefit of having very few “change deltas” for the older ranges; thus, those entire ranges could be easily reprocessed.

As stated above, while the enhanced migration approach did indeed reduce overall downtime, the enhanced migration approach for separating the online and offline ranges of data only provided a limited reduction in overall downtime. For example, a traditional offline migration using standard SAP migration methodology using all available optimization techniques such as table splitting, parallel export/import, etc., took about 60-80 hrs for a 30 TB database. By applying the enhanced migration approach for the top four largest tables (the remaining several thousand tables in a typical SAP system are migrated using the SAP standard method), the approach was able to reduce downtime to around 24 hours. The delta changes on these four tables were also manageable (e.g., around a few hundred changes). Thus, the enhanced migration approach had a limited capability and could only be used for systems that fit the above criteria. This also meant that significant tuning and a longer iterative process were required to reduce the time for migrating the remaining data during the offline window in a reasonable timeframe.

Embodiments described herein improve upon this enhanced migration approach, thus allowing entities to process more data from virtually any type of table regardless of the data profile. In this manner, the present approach can further reduce downtime during a migration process. For example, the present approach may have the capability of executing a migration of any size database with a guaranteed technical downtime of 16 hours or less for very large databases (e.g., database size>30 TB of uncompressed data), and even less than 8 hours for medium-sized databases, as long as certain basic infrastructure requirements are met. Additionally, the base infrastructure requirements of the present approach are generally within the range seen across the industry. Thus, customers are not required to add any new computing capacity to the source systems.

The present approach can automatically process over 99% of the data in the largest tables in a database, while leaving the most active 0.1% to 1% of data for the offline window (as compared to over 10% in the base enhanced migration approach), including those tables that have many sequential ranges. In some embodiments, to achieve this, an analytical method was built using database statistics of these large tables. The system leverages information already captured by existing tools in some cases where it is available. For tables that do not have this statistical information available, an optimized process was developed to collect this information using lightweight database triggers.

In some embodiments, the present method of processing more tables, and more data in them, online may include reducing the amount of changed data that would need to be reprocessed during the downtime phase of the migration for large tables. In the enhanced migration method discussed above, if a table was split into 100 parts and 90 parts were migrated online, if there were changes in five of these parts, these five parts would need to be removed from the target location, re-exported from the source location, and then re-imported into the target location during an offline window. This endeavour is a significant limitation of the base method, as there was previously no way to predict how many of these ranges would have to be removed and replaced. To account for this, one or more techniques described herein analyze update patterns on the large tables. For example, one or more techniques described herein include a method to simply record only the key value of the changed/inserted or deleted record (into the trigger log tables) in the older 99% of the data and reprocess these surgically during the offline window. In other words, instead of removing entire ranges of millions of records as required by the enhanced migration method-the present approach only requires processing a few thousand records using this new key-based trigger log. Such an approach improved the overall handling of the large online tables and provided 100% reliability in the time required to complete the last part of migrating these tables and the changed delta records. Thus, the present approach can guarantee a specific lower downtime, depending on the resources available in source and target environments.

In some embodiments, embodiments described herein may further include extending the cut-off point for online ranges to be the day before the start of the online phase. Such an extension may further reduce the time required to export and import the largest tables.

In some embodiments, one or more techniques described herein may include generalized rules developed based on different types of tables (e.g., data types, key column types, etc.) for highly optimized processing. For example, certain tables may have low CPU impact during export and import processes but may have high IO requirements. In another example, certain tables may have the opposite behaviour. By applying specific rules to these tables, the present approach can conserve compute and IO resources such that these resources may be used optimally for the groups of tables that are appropriate for both the online and offline tables/parts of the database. The current system can achieve this benefit through the disclosed ruleset, which again goes back to analytics and observation over many migrations, database types, and infrastructure combinations.

The foregoing functionality may culminate with the system being able to more accurately estimate the time required for the offline migration phase. For example, by using the table profile and performance of target import for specific types of table data, the present approach may be able to optimize the process for importing the last part of the largest tables and associated delta changes to optimize the amount of time required to complete the import of these parts of the table during the offline phase within the first few hours. Thus, achieving the minimum possible downtime.

Accordingly, as the foregoing indicates, one or more techniques disclosed herein utilize a variety of methods and a variety of information to generate a migration plan that may indicate how many tables are to be migrated and the total volume of data to be processed during an online migration phase and how much data volume will be left for the offline migration phase, depending on the constraints and target technical downtime.

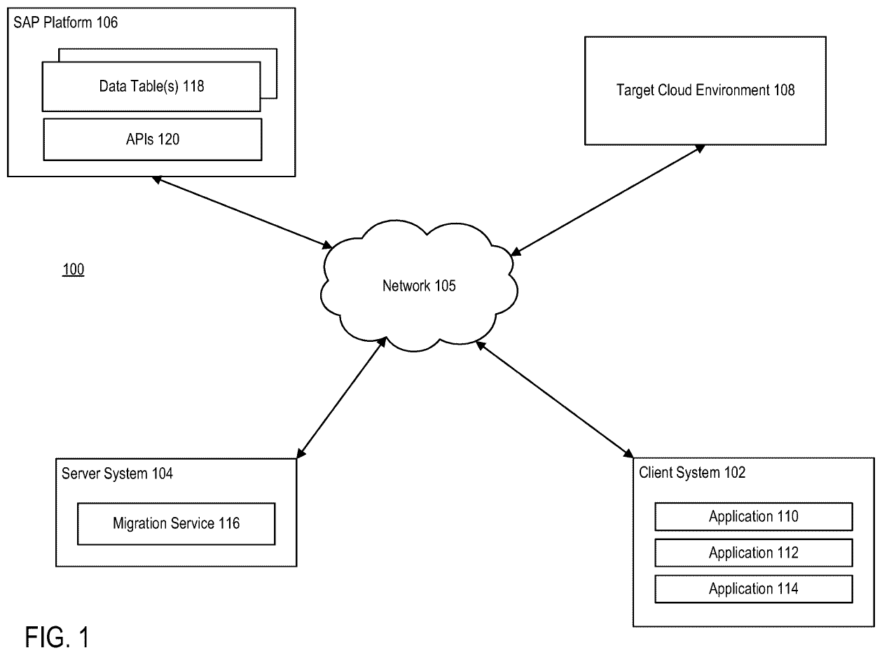

FIG. 1 is a block diagram illustrating a computing environment 100, according to example embodiments. As shown, computing environment 100 may include at least a client system 102, a server system 104, an SAP platform 106, and a target cloud environment 108 communicating via a network 105.

Network 105 may be representative of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be representative of the Internet, a private data network, virtual private network using a public network and/or other suitable connection(s) that enables components in computing environment 100 to send and receiving information between the components of computing environment 100.

Client system 102 may be representative of one or more computing systems operated by a client, customer, or subscriber of server system 104. In some embodiments, client system 102 may be representative of one or more mobile devices, tablets, desktop computers, or any computing systems having the capabilities described herein.

Client system 102 may include at least application 110, application 112, and application 114. Each of application 110, 112, 114 may be representative of one or more software modules. The one or more software modules are collections of code or instructions stored on a media that represent a series of machine instructions (e.g., program code) that implements one or more algorithmic steps. Such machine instructions may be the actual computer code the processor interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Application 110 may be representative of an application or webpage associated with SAP platform 106. In some embodiments, application 110 may be a standalone application associated with SAP platform 106. In some embodiments, application 110 may be representative of a web browser configured to communicate with SAP platform 106. Client system 102 may use application 110 to access functionality of SAP platform 106 by communicating over network 105 to request, for example, a webpage from web client application server of SAP platform 106. For example, application 110 may allow an end user to access one or more data tables or databases hosted by SAP platform 106.

Application 112 may be representative of an application or webpage associated with server system 104. In some embodiments, application 112 may be a standalone application associated with server system 104. In some embodiments, application 112 may be representative of a web browser configured to communicate with server system 104. Client system 102 may use application 112 to access functionality of server system 104 by communicating over network 105 to request, for example, a webpage from web client application server of server system 104. For example, application 112 may allow an end user to provide server system 104 with access to their data tables or databases hosted on SAP platform 106, such that server system 104 can develop a migration strategy for migrating the data tables or databases to target cloud environment 108 in a manner that minimizes downtime.

Application 114 may be representative of an application or webpage associated with target cloud environment 108. In some embodiments, application 114 may be a standalone application associated with target cloud environment 108. In some embodiments, application 114 may be representative of a web browser configured to communicate with target cloud environment 108. Client system 102 may use application 114 to access functionality of target cloud environment 108 by communicating over network 105 to request, for example, a webpage from web client application server of target cloud environment 108. For example, application 114 may allow an end user to access their migrated data tables or databases that are now hosted in target cloud environment 108.

SAP platform 106 may be representative of a larger system associated with SAP. For example, SAP platform 106 may be representative of a portion of the SAP system that hosts one or more data tables 118 or databases associated with client system 102. In some embodiments, SAP platform 106 may include one or more application programming interfaces (APIs) 120. APIs 120 may allow server system 104 to access data tables 118 associated with client system 102.

Server system 104 may be representative of a system external to SAP platform 106 that may be configured to analyze a client's data tables on SAP platform 106 and generate a migration plan for migrating the data tables from SAP platform 106 to target cloud environment with minimum downtown. Server system 104 may include at least migration service 116. Migration service 116 may be configured to analyze data tables 118 or databases associated with client system 102 to identify stable and active data contained therein. Stable data may refer to data that has not changed within a threshold number of seconds, minutes, or days. Active data may refer to data that has changed within the threshold number of seconds, minutes, or days.

As those skilled in the art understand, the process for migrating stable data is typically trivial, as that data is not expected to change during the migration window. However, the process for migrating active data is more difficult, as the data may change during the migration process. As such, migrating active data typically requires system downtime or a freeze on updates in order to ensure data integrity from the source location (e.g., SAP platform 106) to the target location (e.g., target cloud environment 108). Any system downtime or freeze can be disruptive to the operations of a client. To account for this, migration service 116 may be configured to generate a migration plan that reduces any downtime from the conventional standard of several days to merely eight hours or shorter. Such migration plan is able to process over 99% of a client's data in SAP platform 106 during the online phase, while leaving less than 1% of the client's data for the offline window.

To generate such migration plan, migration service 116 may be configured to analyze data tables 118. In some embodiments, migration service 116 may gain access to data tables 118 through one or more APIs 120. During the analysis, migration service 116 may identify the stable data and the active data. As previously indicated, the stable data can be easily migrated from SAP platform 106 to target cloud environment 108 during the online period. In order to generate a migration plan for the active data, migration service 116 may analyze update patterns of data tables 118. For example, migration service 116 may analyze update patterns of data tables 118 to record the key value of the changed/inserted or deleted record in the stable ranges and reprocess these surgically during the offline window. In some embodiments, the specially designed low-impact information triggers may capture the key value of the changed record during the online migration phase for the stable ranges of large tables. The key value may be provided as input to the SAP migration tools to export and import these rows individually during the delta processing of changes during offline phase. This mechanism is designed to remove and replace the logged record and thus can handle deletes/updates and inserts without causing any inconsistency. In other words, instead of removing and replacing entire ranges of millions of records as in the base enhanced method, only a few thousand records may need to be processed in the offline window.

In some embodiments, migration service 116 may use a rule-based approach to generating a migration plan, depending on the type of data table. For example, certain data tables may have low CPU impact while exporting and importing data, but high input/output (IO) requirements. In another example, certain tables may have the reverse behaviour. By applying specific rules for handling these tables, migration service 116 may be able to conserve compute and IO resources, such that they may be used optimally during the migration process. Some of the following rules are followed for a given SAP system depending on the characteristics of that environment:
a) Tables with LOB or CLOB fields typically have a very slow export rate given the large size of each row. Accordingly, adequate memory and time may need to be properly planned to process delta changes related to such tables (some examples in SAP ECC env are, CDCLS, RFBLG, SWWCONT1etc.).
b) Tables having a complex key may also take a significant amount of time to export data. Additional parallelism for deltas related to such tables (COEP, VBOX etc) may need to be planned accordingly.
c) In memory constrained and hardware environments where there is latency in network between application server client and DB, it is ensured that appropriate location of export is chosen (AppServer or DB server) to avoid slowdown of delta exports.
d) In environments where DB software is a very old version, rules may be applied for tables with RAW fields in key columns to avoid search using those as older DB versions are extremely slow in handling such complex keys.

Once migration service 116 generates the migration plan, client system 102 may facilitate the migration of one or more data tables 118 from SAP platform 106 to target cloud environment 108 in accordance with the migration plan. The migration, which entails executing an export of table data ranges from source using parallel jobs and transferring the exported dump files to target and then importing these dumps into target DB, is performed using SAP standard utilities called the system copy tools.

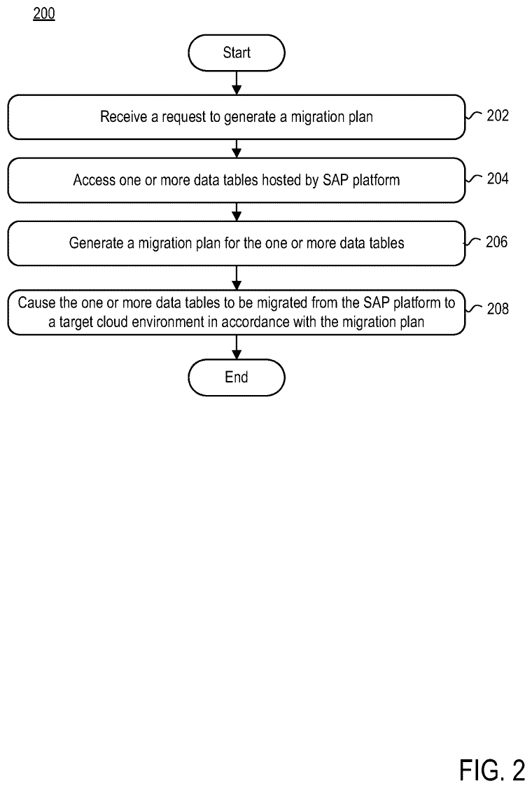

FIG. 2 is a flow diagram illustrating a method 200 of generating a migration plan for migrating data from an SAP platform to a target cloud environment, according to example embodiments. Method 200 may begin at step 202.

At step 202, server system 104 may receive a request to generate a migration plan. In some embodiments, server system 104 may receive the request from client system 102. In some embodiments, the request may indicate one or more data tables on SAP platform 106 that is/are to be migrated from SAP platform 106 to target cloud environment 108.

At step 204, server system 104 may access one or more data tables 118 hosted on SAP platform 106. In some embodiments, server system 104 may gain access to one or more data tables 118 by receiving one or more permissions to access one or more data tables 118 from client system 102. In some embodiments, server system 104 may access one or more data tables via one or more APIs 120.

At step 206, server system 104 may generate a migration plan for one or more tables 118. The migration plan may include an online phase and an offline phase. During the online phase, data may be migrated from SAP platform 106 to target cloud environment 108 while users of client system 102 still have access to the data. During the offline phase, data migrated from SAP platform 106 to target cloud environment 108 may be inaccessible. In some embodiments, to generate the migration plan, migration service 116 may analyze data tables 118. During the analysis, migration service 116 may identify the stable data and the active data. The stable data can be easily migrated from SAP platform 106 to target cloud environment 108 during the online period. For the active data, migration service 116 may analyze update patterns of data tables 118 to determine how and when to migrate them. For example, migration service 116 may analyze update patterns of data tables 118 to record the key value of the changed/inserted or deleted record and reprocess these surgically during the offline window.

In some embodiments, migration service 116 may use a rule-based approach to generating a migration plan, depending on the type of data table. For example, certain data tables may have low CPU impact while exporting and importing data, but high input/output (IO) requirements. In another example, certain tables may have the reverse behaviour. By applying specific rules for handling these tables, migration service 116 may be able to conserve compute and IO resources, such that they may be used optimally during the migration process.

At step 208, server system 104 may cause data to be migrated from SAP platform 106 to target cloud environment 108 in accordance with the migration plan. In some embodiments, server system 104 may cause the data to be migrated by providing SAP platform 106 with the migration plan to execute. In some embodiments, server system 104 may cause the data to be migrated by providing client system 102 with the migration plan to execute. In some embodiments, server system 104 may cause the data to be migrated by executing the migration plan on behalf of client system 102.

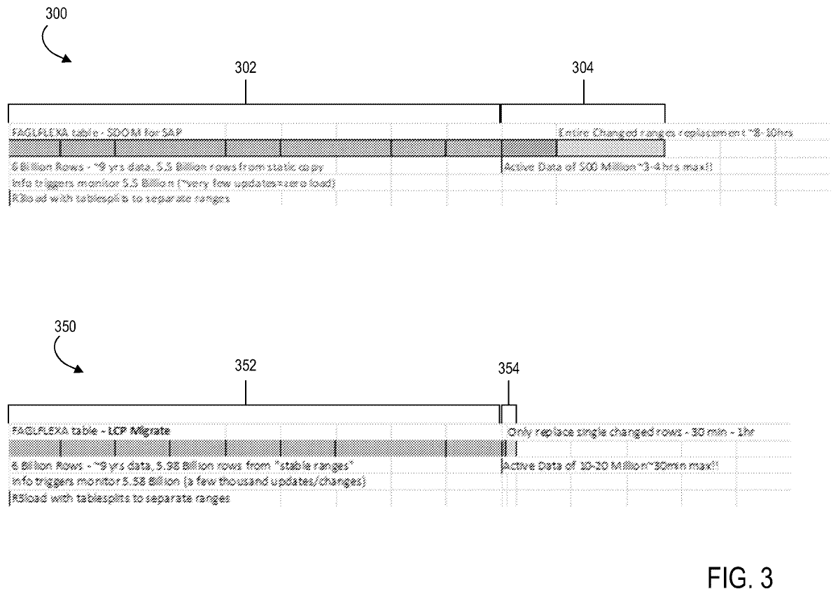

FIG. 3 is a block diagram illustrating a comparison between a base enhanced migration process 300 and a migration process 350 using migration service 116, according to example embodiments. As shown, in base enhanced migration process 300, while the majority of the migration process is performed during the online phase 302, there is still a sizeable portion of data that needs to be migrated during the offline phase 304. In comparison, in migration process 350, a larger portion of the same data tables can be migrated in the online phase 352, thus leaving a smaller portion of data that needs to be migrated in the offline phase 354. In this manner, migration process 350 reduces the overall downtime for client system 102. In SAP's standard migration method with traditional full offline process, the entire table would need to be processed during offline window, which can be several times the outage required with migration service 350.

As those skilled in the art understand, the above techniques provide a substantial benefit to SAP customers by providing a more efficient-in both cost and speed-solution compared to other conventional solutions in the market that afford the same downtime reduction using various online migration techniques.

Most other vendors'solutions including SAP's own Near Zero DownTime Migration options involve taking a static copy of the productive system, migrating that to target, marking all tables on source DB from that point forward to record all new changes and then replay these changes using different synching mechanisms to the target. This causes a significant increase in hardware required on the source side and also has detrimental impact in update performance of the productive environment affecting customer's business.

In contrast, the one or more techniques disclosed herein separate the stable and active ranges and move only the stable parts that have very minimal change, while monitoring those stable ranges during online export and capturing these sparse changes for replay into target. The approach then processes the active range (with bulk import-very fast) and the stable range ‘delta’ (with record replacement) during a short offline window. In this manner, the foregoing techniques only need to process a few thousand record changes, while other solutions need to sync hundreds of millions of changes. This fundamental difference results in the capability to give the 80% or more downtime reduction without the need for any new hardware on source and also at a much lower cost and impact to the customer's business. The simplicity of the approach also affords the customer production mock runs without causing any outage to their running production environment, which again is a significant improvement in capability over other solutions in the market.

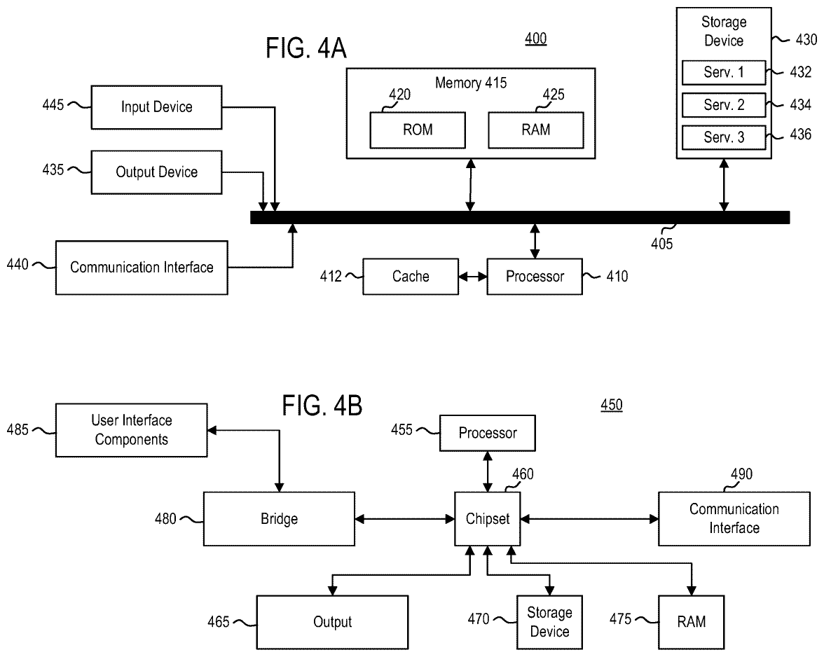

FIG. 4A illustrates an architecture of system bus computing system 400, according to example embodiments. One or more components of system 400 may be in electrical communication with each other using a bus 405. System 400 may include a processor (e.g., one or more CPUs, GPUs or other types of processors) 410 and a system bus 405 that couples various system components including the system memory 415, such as read only memory (ROM) 420 and random access memory (RAM) 425, to processor 410. System 400 can include a cache of high-speed memory connected directly with, in close proximity to, or integrated as part of processor 410. System 400 can copy data from memory 415 and/or storage device 430 to cache 412 for quick access by processor 410. In this way, cache 412 may provide a performance boost that avoids processor 410 delays while waiting for data. These and other modules can control or be configured to control processor 410 to perform various actions. Other system memory 415 may be available for use as well. Memory 415 may include multiple different types of memory with different performance characteristics. Processor 410 may be representative of a single processor or multiple processors. Processor 410 can include one or more of a general purpose processor or a hardware module or software module, such as service 1 432, service 2 434, and service 4 436 stored in storage device 430, configured to control processor 410, as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction with the system 400, an input device 445 which can be any number of input mechanisms, such as a microphone for speech, a touch-sensitive screen for gesture or graphical input, keyboard, mouse, motion input, speech and so forth. An output device 435 (e.g., a display) can also be one or more of a number of output mechanisms known to those of skill in the art. In some instances, multimodal systems can enable a user to provide multiple types of input to communicate with system 400. Communications interface 440 can generally govern and manage the user input and system output. There is no restriction on operating on any particular hardware arrangement and therefore the basic features here may easily be substituted for improved hardware or firmware arrangements as they are developed.

Storage device 430 may be a non-volatile memory and can be a hard disk or other types of computer readable media that can store data that are accessible by a computer, such as magnetic cassettes, flash memory cards, solid state memory devices, digital versatile disks, cartridges, random access memories (RAMs) 425, read only memory (ROM) 420, and hybrids thereof.

Storage device 430 can include services 432, 434, and 436 for controlling the processor 410. Other hardware or software modules are contemplated. Storage device 430 can be connected to system bus 405. In one aspect, a hardware module that performs a particular function can include the software component stored in a computer-readable medium in connection with the necessary hardware components, such as processor 410, bus 405, output device 435 (e.g., a display), and so forth, to carry out the function.

FIG. 4B illustrates a computer system 450 having a chipset architecture, according to example embodiments. Computer system 450 may be an example of computer hardware, software, and firmware that can be used to implement the disclosed technology. System 450 can include one or more processors 455, representative of any number of physically and/or logically distinct resources capable of executing software, firmware, and hardware configured to perform identified computations. One or more processors 455 can communicate with a chipset 460 that can control input to and output from one or more processors 455. In this example, chipset 460 outputs information to output 465, such as a display, and can read and write information to storage device 470, which can include magnetic media, and solid-state media, for example. Chipset 460 can also read data from and write data to storage device 475 (e.g., RAM). A bridge 480 for interfacing with a variety of user interface components 485 can be provided for interfacing with chipset 460. Such user interface components 485 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by one or more processors 455 analyzing data stored in storage device 470 or 475. Further, the machine can receive inputs from a user through user interface components 485 and execute appropriate functions, such as browsing functions by interpreting these inputs using one or more processors 455.

It can be appreciated that example systems 400 and 450 can have more than one processor 410 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product defines the functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method of migrating a database from an SAP system to a target cloud environment comprising:
receiving, by a computing system, a request to generate a migration plan for migrating data from an SAP system to a target cloud environment;
accessing, by the computing system, the data hosted by the SAP system;
generating, by the computing system, the migration plan for migrating the data from the SAP system to the target cloud environment, the migration plan comprising an online phase and an offline phase, wherein, in the online phase, stable data and a first portion of active data that has not changed within a threshold period of time is migrated to the target cloud environment, and, wherein, in the offline phase, a second portion of the active data that has changed within the threshold period of time is migrated to the target cloud environment; and
causing, by the computing system, the data to be migrated from the SAP system to the target cloud environment in accordance with the migration plan.

2. The method of claim 1, wherein generating, by the computing system, the migration plan comprises:
recording key values of changed, inserted, or deleted data records in the data.

3. The method of claim 2, wherein causing, by the computing system, the data to be migrated comprises:
reprocessing the changed, inserted, or deleted data records during the offline phase.

4. The method of claim 1, wherein generating, by the computing system, the migration plan comprises:
determining a portion of the data that has a lower processing impact during migration than a further portion of the data.

5. The method of claim 1, wherein generating, by the computing system, the migration plan comprises:
determining a portion of the data that has lower input/output requirements during migration than a further portion of the data.

6. The method of claim 1, wherein generating, by the computing system, the migration plan comprises:
analyzing patterns in the data to determine which portions of the data to migrate during the online phase.

7. The method of claim 1, wherein causing, by the computing system, the data to be migrated from the SAP system to the target cloud environment in accordance with the migration plan comprises:
providing the migration plan to one of the SAP system or a client system for execution.

8. A non-transitory computer readable medium comprising one or more sequences of instructions, which, when executed by a processor, causes a computing system to perform operations comprising:
receiving, by the computing system, a request to generate a migration plan for migrating data from an SAP system to a target cloud environment;
accessing, by the computing system, the data hosted by the SAP system;
generating, by the computing system, the migration plan for migrating the data from the SAP system to the target cloud environment, the migration plan comprising an online phase and an offline phase, wherein, in the online phase, stable data and a first portion of active data that has not changed within a threshold period of time is migrated to the target cloud environment, and, wherein, in the offline phase, a second portion of the active data that has changed within the threshold period of time is migrated to the target cloud environment; and
causing, by the computing system, the data to be migrated from the SAP system to the target cloud environment in accordance with the migration plan.

9. The non-transitory computer readable medium of claim 8, wherein generating, by the computing system, the migration plan comprises:
recording key values of changed, inserted, or deleted data records in the data.

10. The non-transitory computer readable medium of claim 9, wherein causing, by the computing system, the data to be migrated comprises:
reprocessing the changed, inserted, or deleted data records during the offline phase.

11. The non-transitory computer readable medium of claim 8, wherein generating, by the computing system, the migration plan comprises:
determining a portion of the data that has a lower processing impact during migration than a further portion of the data.

12. The non-transitory computer readable medium of claim 8, wherein generating, by the computing system, the migration plan comprises:
determining a portion of the data that has lower input/output requirements during migration than a further portion of the data.

13. The non-transitory computer readable medium of claim 8, wherein generating, by the computing system, the migration plan comprises:
analyzing patterns in the data to determine which portions of the data to migrate during the online phase.

14. The non-transitory computer readable medium of claim 8, wherein causing, by the computing system, the data to be migrated from the SAP system to the target cloud environment in accordance with the migration plan comprises:
providing the migration plan to one of the SAP system or a client system for execution.

15. A system comprising:
a processor; and
a memory having programming instructions stored thereon, which, when executed by the processor, causes the system to perform operations comprising:
receiving a request to generate a migration plan for migrating data from an SAP system to a target cloud environment;
accessing the data hosted by the SAP system;
generating the migration plan for migrating the data from the SAP system to the target cloud environment, the migration plan comprising an online phase and an offline phase, wherein, in the online phase, stable data and a first portion of active data that has not changed within a threshold period of time is migrated to the target cloud environment, and, wherein, in the offline phase, a second portion of the active data that has changed within the threshold period of time is migrated to the target cloud environment; and
causing the data to be migrated from the SAP system to the target cloud environment in accordance with the migration plan.

16. The system of claim 15, wherein generating the migration plan comprises:
recording key values of changed, inserted, or deleted data records in the data.

17. The system of claim 16, wherein causing the data to be migrated comprises:
reprocessing the changed, inserted, or deleted data records during the offline phase.

18. The system of claim 15, wherein generating the migration plan comprises:
determining a portion of the data that has a lower processing impact during migration than a further portion of the data.

19. The system of claim 15, wherein generating the migration plan comprises:
determining a portion of the data that has lower input/output requirements during migration than a further portion of the data.

20. The system of claim 15, wherein generating the migration plan comprises:
analyzing patterns in the data to determine which portions of the data to migrate during the online phase.
